(19) United States
(12) Patent Application Publication
(10) Pub. No.: US 2021/0045575 A1
(43) Pub. Date: Feb. 18, 2021

(54) POT LID WITH SIGNALING DEVICE

(71) Applicant: FISSLER GMBH, Idar-Oberstein (DE)

(72) Inventors: Arno THELEN, Idar-Oberstein (DE); Benjamin HEIDRICH, Idar-Oberstein (DE)

(21) Appl. No.: 17/046,925

(22) PCT Filed: Apr. 15, 2019
(86) PCT No.: PCT/EP2019/059609

§ 371 Date: Oct. 12, 2020

(30) Foreign Application Priority Data
Apr. 30, 2018 (DE) 10 2018 110 387.5
Dec. 21, 2018 (DE) 10 2018 133 304.8

(51) Int. Cl. A47J 36/06

(52) U.S. Cl. CPC A47J 36/06; A47J 2202/00

(57) ABSTRACT

A low-pressure vessel cover includes a plate-shaped base for placing on a vessel edge of a low-pressure vessel, a first opening in the base, and an acoustic signaling device for detecting a boiling point of a liquid which is heated in the low-pressure vessel. The signaling device includes a note-sounding plate system, which has a note-sounding plate, a note-sounding plate opening, and a note-sounding tongue. The note-sounding plate system is arranged in a first flow channel which extends from the first opening in the base to a first outlet opening such that the note-sounding tongue is excited by out-flowing fluid and generates a signaling tone of at least 40 dB.

### TECHNICAL FIELD

The present disclosure relates to a low-pressure vessel lid having a signalling device for detecting boiling, in particular the onset of boiling of a liquid. The detection is associated with an acoustic signal.

### BACKGROUND

The term low-pressure vessel relates to vessels or cooking vessels which are not sealed by additional measures in order to produce excess pressure therein. In other words, these are normal cooking pots or vessels in which liquids, for example, water can be heated and brought to the boil. In these vessels the excess pressure produced as a result of the steam pressure is substantially determined by the weight of the lid (counterpressure due to weight force) as well as the accuracy of fit of the lid on the contact surfaces to the pot.

Such cooking pots or heatable cooking vessels are still the most commonly used means worldwide for the preparation of food. Nowadays, the heating usually takes place by means of electrical or gas-driven heating systems which are integrated in so-called single hotplates or built-in hobs. As standard, such heating systems only have a power control by means of which the user can set a defined power of, for example, 600 Watt in stage 1, 1200 Watt in stage 2, 1800 Watt in stage 3 etc. A temperature control or a closed temperature control circuit is not provided as standard.

The said heating systems have the result that during the cooking process the user must frequently adjust the power setting. In this case, it is important that the power matching takes place at the right time which in turn means that the user must observe and monitor the cooking process in a time-consuming manner, at least at regular intervals.

Mechanical signalling devices are substantially only known for vessels in which a relatively high excess pressure is produced. The most well-known example are tea kettles which are sealed apart from the signalling opening so that steam under high pressure escapes through the signalling opening. Electronic signalling devices are also known for low-pressure cooking vessels but these are expensive to manufacture and only function insufficiently reliably.

Known from DE 103 114 95 B3 is a signalling device which can be attached to a cooking pot and which also detects the boiling of water. This comprises a relatively small closed container in which liquid can be poured. A whistle is arranged in the lid of the container. The container is dipped into the water to be heated in the cooking pot so that when the water in the cooking pot begins to boil, the water in the container also begins to boil. The steam formed in this case escapes through a whistle in the lid and triggers a whistle signal. In this external device the necessary pressure in the container is also correspondingly high.

DE 20 2013 001 944 U1 discloses a system which is intended to prevent boiling over or to indicate a boiling of a liquid. This is formed by a double-walled pot lid in which a liquid can be inserted. This liquid is also heated during boiling and the steam formed flows through an opening of the signaller having a note-sounding plate with note-sounding tongue placed thereon.

The structure of such a pot lid is extremely complex and is also based on the principle that the vessel is tightly closed apart from the note-sounding plate opening of the signaller so that sufficient excess pressure can be produced.

### SUMMARY

The present disclosure provides a low-pressure vessel lid which acoustically displays a boiling of liquid heated in the low-pressure vessel. It is essential that the steam pressure produced in the cooking vessel should be used. The acoustic signaller should also respond reliably at relatively low excess pressure in the vessel. The signal strength should reach at least 50 dBA.

This is achieved by providing a low-pressure vessel lid which has the features of the independent Patent claim 1.

The disclosure uses as signalling device a note-sounding plate system with effective note-sounding tongue as signaller. The effective note-sounding tongue is usually a metal material strip which is fastened at one of the ends thereof on a close-fitting, usually also metal frame of the note-sounding plate. In the rest state, the free movable part of the note-sounding tongue almost completely covers the note-sounding plate opening of the note-sounding plate apart from a circumferential air gap surrounding the note-sounding tongue. If an ascending gaseous volume flow is formed in the cooking pot, for example, steam, the tongue begins to vibrate through the note-sounding plate and thereby produces a sound. The note-sounding tongue and the note-sounding plate can be executed as multi-part or also as one-piece. The note-sounding plate system can, for example, be formed from stainless steel.

According to the disclosure, a circumferential air gap between the note-sounding tongue and the note-sounding frame or the note-sounding plate is reduced as much as possible so that pressure losses are also reduced as much as possible. The note-sounding tongue therefore almost completely covers the note-sounding plate opening in the note-sounding plate. It has been shown that the note-sounding tongue according to the disclosure should lid approximately 95% to 99%, preferably 97 to 98% of the note-sounding plate opening in the note-sounding plate, so that it begins to vibrate at the lowest possible pressure. It is essential that the note-sounding tongue can vibrate freely through the note-sounding plate opening of the note-sounding plate. In order to furthermore promote an easy and rapid response of the note-sounding tongue, this is made of an elastic material having the smallest possible thickness, for example, stainless steel having a thickness of approximately 0.2 mm.

As already explained, the note-sounding tongue is preferably placed on the note-sounding plate at the end via the note-sounding tongue foot. If that side of the note-sounding plate on which the note-sounding tongue is placed, is aligned contrary to the flow direction of the fluid, i.e. facing the fluid, the fluid initially impinges on the note-sounding tongue. In this case, the static pressure acting on the surface of the note-sounding tongue directed contrary to the flow helps to move the note-sounding tongue a little in the direction of the note-sounding plate. The essential driving force in this case however is initially the underpressure behind the note-sounding tongue in the channel of the note-sounding plate. This is formed according to the Bernoulli equation as a result of the higher flow rate behind the note-sounding tongue which is formed due to the cross-sectional narrowing through the gap between note-sounding tongue and note-sounding plate in the flow channel. The underpressure pulls the note-sounding tongue in the direction of the note-sounding plate until the tongue has closed the channel. As a result of the closure, the flow abruptly ceases with the result that underpressure is no longer present. The spring force of the note-sounding tongue then comes into effect and moves this back into the zero position, and the sequence begins from the front.

In the starting position, i.e. the initial position, the note-sounding tongue requires a so-called release distance, otherwise the system would not function. That is, the note-sounding tongue according to the disclosure is bent so that towards its free end this has a greater distance of 0.2-0.5 mm from the note-sounding plate than at the note-sounding tongue foot (absolutely towards zero). The gap thus formed so to speak forms the active flow cross-section. The circumferential gap in the flat position from note-sounding tongue to note-sounding plate is merely required so that the note-sounding tongue does not stick in the note-sounding plate, ideally this would therefore also be zero.

As a result of the mass inertia and the static pressure, the vibration amplitude then increases so that the note-sounding tongue dips deeply into the opening of the note-sounding plate or depending on the pressure conditions is immersed completely and conversely strikes out significantly via the zero position. The thicker the note-sounding plate, the higher the vibration amplitude and therefore the attainable loudness can be and conversely. The reason for this is that as soon as the note-sounding tongue is completely immersed through the note-sounding plate, the channel is opened again and thus the static pressure is lost (the acceleration comes to a standstill).

Such a note-sounding plate system is usually only suitable for devices which provide a significant excess pressure since the note-sounding plate requires this excess pressure which is composed of static and dynamic pressure to be able to produce a sound. In wind instruments this necessary pressure is readily produced by the player, even in tea kettles with boiling water, more than sufficient excess pressure is provided as a result of the sealed vessel. Since a normal cooking pot usually has no seals, the excess pressure that can be generated compared, for example, to a tea kettle is however several factors lower. The pressure in low-pressure vessels is maximum of 0.04 bar but is usually significantly lower, usually in the 1/1000 bar range.

The excess pressure also ensures that condensate forming on the note-sounding plate system is blown away and therefore the note-sounding tongue can no longer be blocked.

For the said reasons, the use of a note-sounding plate system at first glance seems unsuitable for the object to be solved since at the low excess pressures described this barely responds or does not respond at all and furthermore a relative liability to condensate should be expected.

Despite this, the inventor has pursued this idea further and ascertained that contrary to expectations, a note-sounding plate system can fundamentally be used. According to the disclosure, the sensitivity to condensate is also reduced by various measures.

In a particularly advantageous embodiment, a flow channel is provided between the opening in the plate-shaped base plate of the low-pressure vessel lid and the note-sounding plate system, through which channel the fluid, for example, steam, flows from the cooking vessel to the note-sounding plate system.

In order to prevent perturbing formation of condensate during the heating phase of the liquid in the vessel a component having a high thermal capacity can be arranged in the flow channel in the flow direction of the fluid between the opening in the lid and the note-sounding plate system. The component must have a higher thermal capacity than the note-sounding plate system itself since as a result, at least until the thermal capacity is used up, said component remains colder than the note-sounding plate system and the condensate is thus precipitated on this component. As a result of the high thermal capacity of the component, this heats up very slowly with the result that it can allow more steam to condense over time. This is important in particular during the heating phase, i.e. until sufficient steam pressure is available for the generation of a sound by the note-sounding plate. The component loses its effect with its increasing heating so that after the heating phase, the full fluid flow reaches the note-sounding plate.

Instead of an additional component with correspondingly high thermal capacity, according to the disclosure, the wall of the flow channel itself can be fabricated, at least in some regions, from a material having a thermal capacity which exceeds the thermal capacity of the note-sounding plate.

In a further advantageous embodiment, the flow channel towards the note-sounding plate system can be kept closed during the heating phase by a valve arranged in the flow channel. This valve opens when the heating phase is ended or when a sufficient pressure is provided by the fluid in order to bring the note-sounding tongue of the note-sounding plate system to vibrate immediately. As a result, the perturbing formation of condensate on the note-sounding plate during the heating phase is completely avoided. The valve can, for example, be designed as a weight valve but alternatively also by a usual excess pressure valve according to the prior art.

It has been shown that the note-sounding tongue then reacts particularly sensitively when the angle of incidence of the note-sounding plate system is approximately 35° to 55°, preferably 45° to the flow direction of the fluid or to the perpendicular direction. Furthermore, as a result of this arrangement, the condensate sensitivity of the note-sounding plate system is reduced, in particular when the side of the note-sounding plate on which the note-sounding tongue is mounted, is inserted contrary to the flow direction and the note-sounding tongue foot points downwards towards the lid, i.e. in the perpendicular direction when used as intended. The force of gravity and the angle of incidence of the flow therefore help to divert the condensate in the direction of the note-sounding tongue foot.

The note-sounding plate system can be improved according to the disclosure in relation to improvement in the condensate behaviour whereby condensate grooves are provided on the note-sounding plate. As a result, a sufficient but not too large additional cross-section for the fluid flow is formed which ensures that during the heating phase the fluid can escape more rapidly instead of condensing on the note-sounding plate system and therefore blocking the note-sounding tongue.

In addition to a series of metal alloys, other materials are also feasible for producing the note-sounding plate system. In addition to various high-performance plastics, fundamentally all materials which have sufficiently good properties in relation to elasticity, fatigue strength, tensile strength etc. are suitable.

A further measure according to the disclosure is the coating of the note-sounding plate system with a hydrophilic or hydrophobic coating. A hydrophilic coating brings about a spreading of the condensate droplets so that these have a less perturbing effect as a result of the more homogeneous mass distribution on the note-sounding plate system. A hydrophobic coating brings about a significantly better flow-off of the perturbing condensate droplets. It has also been shown that the note-sounding plate system then has a particularly positive condensate behaviour when it is formed from tin-plated material.

According to the disclosure, the note-sounding plate system has the lowest possible total mass which reduces the total thermal capacity of the note-sounding plate system. In conjunction with the incorporation in the moulded part, the note-sounding plate system is also sufficiently firmly held in the case of very large temperature differences which is relevant for the necessary vibration.

According to the disclosure, the note-sounding plate system is inserted into a thermally stable and readily flexible moulded part which is solid, at least in some regions, preferably comprising silicone. This moulded part is used as a vibration counter-bearing and at the same time as a thermal insulator which additionally reduces the condensation sensitivity of the note-sounding plate system.

The note-sounding plate system is heated very rapidly by the flowing fluid which in turn results in a very small amount of condensate formation. The adhesion of the condensate still forming is significantly reduced by the gentle vibrations of the note-sounding plate system which are made possible by the flexible moulded part. The condensate droplets released in this manner can then run off downwards in the drain direction as a result of the preferred positioning of the note-sounding plate with note-sounding tongue foot and an angle of incidence of 35 to 50° with respect to the flow or perpendicular direction without blocking the note-sounding tongue.

A further measure according to the disclosure for reducing the formation of condensate on the note-sounding plate system is an optimized construction of the cooking vessel/lid edge system which ultimately, as a result of the plane-parallel corresponding surfaces increases the system tightness and therefore the excess pressure prevailing in the cooking vessel. As a result of the higher excess pressure which still lies significantly below the pressure of, for example, tea kettles, on the one hand there are more response reserves for the note-sounding plate system, on the other hand the adhesion of condensate is further reduced by the higher flow rate and vibration amplitude. It has also be shown that a liquid film is formed between cooking vessel and vessel lid due to the condensing steam, which film produces an additionally sealing effect.

A further possibility for reducing the failure rate of the note-sounding plate system due to condensate formation by pure steam, is fundamentally ensuring sufficient pressure in the vessel. This is specifically important in a low-pressure vessel since even a small reduction in the pressure can have the result that the pressure-sensitive signalling device does not function perfectly. However, if the pressure in the low-pressure vessel remains in the upper pressure range, the inflow pressure and volume flow are sufficient to rather “blow free” the note-sounding plate system. That is, the adhering and perturbing condensate is pressed away and entrained so that the note-sounding tongue is no longer further prevented from setting itself in motion. Without an additional sealing element between pot and lid on the other hand, pressure losses can possibly tend to occur since on the one hand, the tightness as a result of the manufacturing tolerances and on the other hand, the lid weight as a counter-force are frequently no longer sufficient.

In one embodiment according to the disclosure, a sealing element is therefore provided between pot and lid that exclusively seals the system by means of the surface pressure produced by the lid weight. The increase in pressure attainable by this design is limited by the lid weight but already achieves a substantial reduction in the failure rate.

A further particularly advantageous measure according to the disclosure provides a sealing element in a special design which produces an additional frictional connection. The frictional connection can be arbitrarily adjusted up to a certain limit and ensures the desired pressure level. Additionally, a safety valve can be provided which limits the theoretically attainable pressure so that the lid cannot under any circumstances become detached from the pot, endangering the user. For these advantageous embodiments it also holds that the maximum pressure produced does not exceed approximately 0.04 bar.

A further measure according to the disclosure to ensure the necessary pressure in the low-pressure vessel provides for increasing the lid weight. This can be accomplished on the one hand by means of geometry, material thickness and material or however, according to the disclosure by means of an additional weight which is achieved by a special geometry of the fastening screw for the lid handle.

In a particularly advantageous embodiment, the low-pressure vessel lid has a lid handle in which the signalling device according to the disclosure with all the relevant components is accommodated. Accordingly, the opening in the base plate of the lid through which the fluid can escape is arranged in the region of the lid handle or connected to this via a flow channel.

In a particularly advantageous embodiment, the signalling device can be switched on and off so that the user can select whether he would like to use this or not. Switching off is based on the principle that the escaping fluid cannot reach the signalling device but is diverted to the surroundings in another way.

According to the disclosure, the plate-shaped base plate of the low-pressure vessel lid has two openings which each enable an outflow of fluid or steam. A first flow channel connects a first opening to the note-sounding plate system so that escaping steam can generate an acoustic signal. A second flow channel connects the second opening to the surroundings so that via this the fluid can be led out directly without an acoustic signal. The use of two openings has therefore proved advantageous since the note-sounding plate system ultimately significantly reduces the cross-section of the outlet opening so that too-high pressure can form inside the cooking vessel which can result in lifting and clattering of the cooking vessel. The use of two openings on the other hand enables a significantly larger fluid volume to flow out.

As a result of a rocker system (rocker switch) for switching the valves, the following valve positions are possible:
Position 1: valve 1 (note-sounding plate) open/valve 2 closed,
Position 2: valve 1 (note-sounding plate) closed/valve 2 open
Position 3: valve 1 (note-sounding plate) closed/valve 2 closed

It is provided that after the user has heard the acoustic signal for a sufficiently long time and as a result of the reasons listed (for example, clattering) the user changes the valve position. In this example, from position 1 to 2.

In a particularly advantageous embodiment, the lid handle has two switchable valves which can each close or release one of the openings. It has been shown that the use of a rocker switch is particularly user-friendly since the valves can rapidly and easily be opened and closed by means of this switch. For example, two telescopic locking bolts with plate seals arranged at the end can be moved in the direction of openings by means of the rocker switch. In this case, these engage with grooves in parallel-guided spring plates and remain in the selected position. In a middle position of the rocker switch both valves are closed. An actuation of the rocker switch in one direction brings about a lifting of the first valve from the first opening and therefore a release of the first flow channel in the direction of the note-sounding plate system. A depression of the rocker switch on the other side brings about a lifting of the second valve and therefore a release of the second opening, with the result that for example steam can be led out directly to the surroundings.

Preferably the underside of the lid handle is completely sealed against the plate-shaped base plate of the lid by a removable form seal, preferably made of silicone. As a result, direct contact of food with the possibly critical materials is avoided and also a contamination of the lid fittings is eliminated. Cleaning is also made easier by the removability of the form seal.

Additional locking positions for a fine adjustment of the flow cross-sections of the respective flow channels can also be provided in the lid handle. In a further embodiment, a double valve system can also be provided in combination with an additional seal between the cooking vessel and the lid of the low-pressure vessel so that a low-pressure cooking stage setting of ≤0.04 bar is possible.

A further feature according to the disclosure is a design of the note-sounding plate system for frequencies 400 Hz. Such a low-frequency design also results at very low pressures in a significantly higher loudness than would be the case at higher frequencies, which has been confirmed empirically in experiments.

In a further possible embodiment, the installation of a plurality of note-sounding plate systems to achieve a harmonic chord is feasible.

The disclosure will be described in detail hereinafter with reference to the following figures. The figures merely show one particularly advantageous embodiment which should not delimit the scope of protection of the companies. In particular the measurements and dimensions can vary.

### BRIEF DESCRIPTION OF THE DRAWINGS

In the figures:

FIG. 1: shows a note-sounding plate system in front view,

FIG. 2: shows a note-sounding plate system in sectional view according to the line of intersection A/A from FIG. 1,

FIG. 3: shows a lid handle with double valve system in the closed state,

FIG. 4: shows the lid handle from FIG. 3 in the open/closed state,

FIG. 5: shows a view from underneath of the lid handle with incorporated form seal and inserted note-sounding plate system,

FIG. 6: shows the form seal from FIG. 5 with inserted note-sounding plate system in the released state, and

FIG. 7: shows a note-sounding plate system according to the disclosure.

### DETAILED DESCRIPTION OF THE DRAWINGS

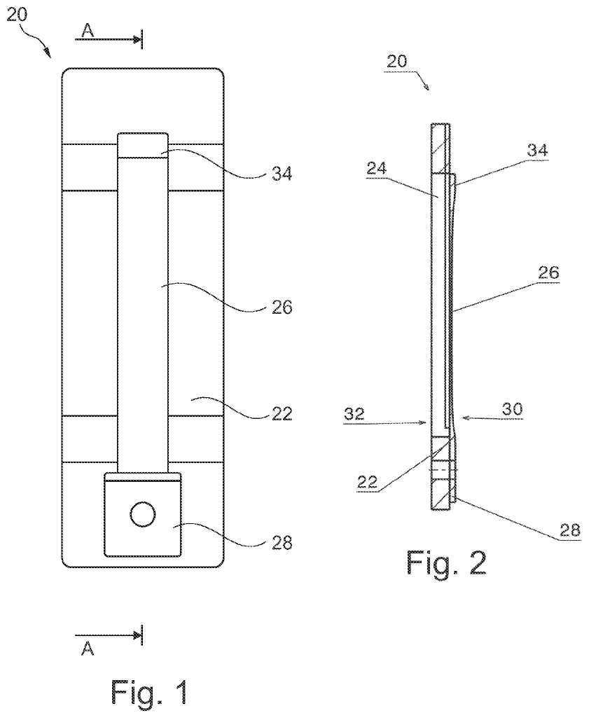

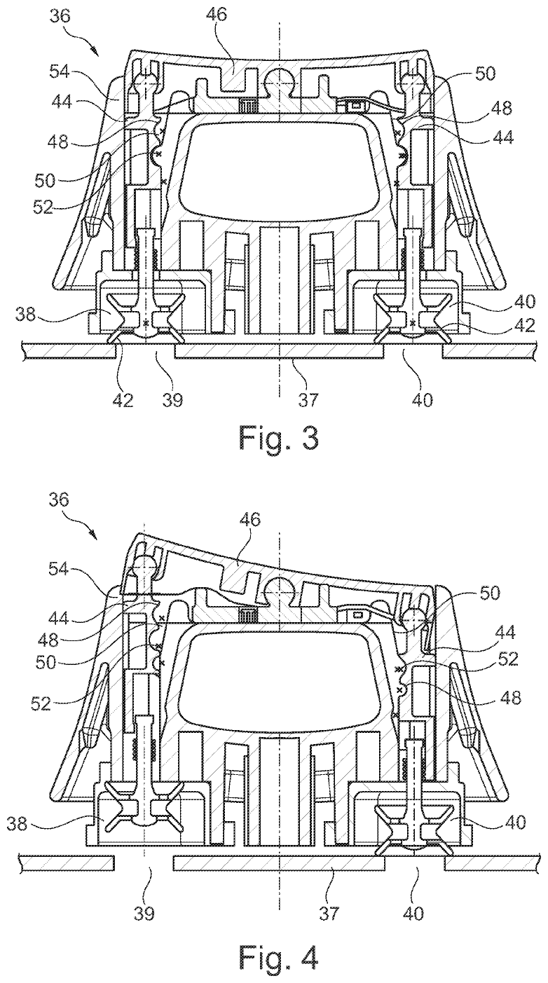

FIGS. 1 and 2 show a note-sounding plate system 20 in front view (FIG. 1) and in sectional view (FIG. 2) according to the line of intersection A/A from FIG. 1.

A note-sounding plate 22 with a note-sounding plate opening 24 is shown. The note-sounding plate 22 forms a type of frame which is largely covered by a note-sounding tongue 26. The note-sounding tongue 26 is fastened, preferably welded or riveted, at the end of the note-sounding plate 22 by means of its note-sounding tongue foot 28. Thus, the note-sounding plate 22 has a note-sounding tongue side 30 and a rear side 32.

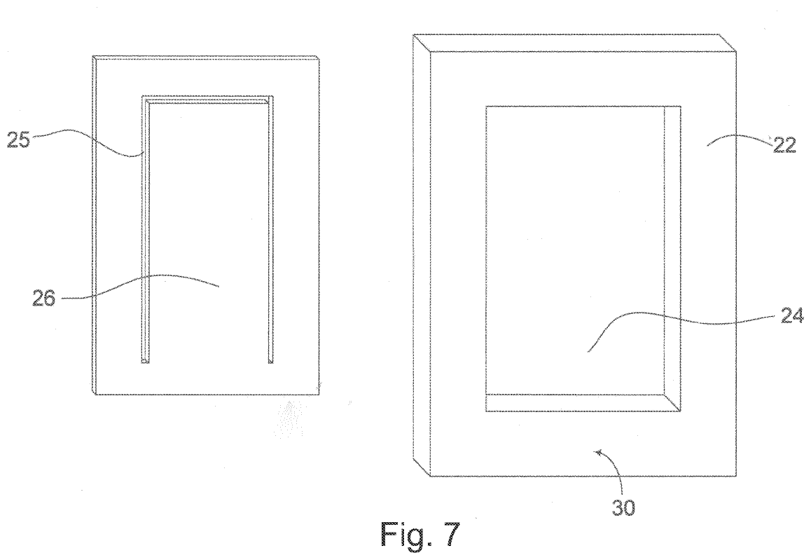

The note-sounding tongue 26 largely covers the note-sounding plate opening 24 but a circumferential air gap 25 (cannot be seen, cf. FIG. 7) having the smallest possible width remains. It is essential that the air gap is sufficiently large to enable a vibration of the note-sounding tongue 26 but at the same time, the air gap should be as small as possible to provide the largest possible closed surface for the incident fluid. It has been shown that of the total area of the note-sounding plate opening 24, a maximum of 4%, preferably only 1 to 2% should remain free.

In the exemplary embodiment shown, the note-sounding tongue 26 has a note-sounding tongue head 34 which has a greater thickness than the remaining course of the note-sounding tongue 26. This results in an increased mass at the free end of the note-sounding tongue 26 which in turn supports the vibration of the note-sounding tongue 26. The mass distribution directly determines the frequency, in the exemplary embodiment the note-sounding tongue achieves approximately 400 Hz.

FIGS. 3 and 4 show a preferred lid handle 36 in cross-section, once in the closed state (FIG. 3) and one in the open/closed state (FIG. 4). The lid handle 36 is arranged on a plate-shaped base plate 37 of a lid with a first opening 39 and a second opening 41. Through these openings 39, 41 in the base plate fluid or steam can escape from a low-pressure cooking vessel also not shown and flow into the lid handle 36. According to the disclosure, the openings 39, 41 can be closed by means of a first valve 38 and a second valve 40. The valves 38, 40 have plate seals 42 at the end for resting on the base plate. Said valves are connected to a rocker switch 46 via telescopic locking bolts 44.

Extending parallel to the telescopic locking bolts 44 which have locking grooves 48 are spring plates 50 with locking lugs 52 which can engage in the locking grooves 48 of the telescopic locking bolts 44. The telescopic locking bolts 44 each contain a spring-loaded pin which has the effect that in a central position of the rocker switch 46, as shown in

FIG. 3, both valves 38, 40 or plate seals 42 rests on the base plate 37 and close the openings 39, 41.

The rocker switch 46 is mounted in the lid handle housing 54 in which all the other elements of the note-sounding plate system 20 are arranged.

Only the following valve positions are possible as a result of the rocker switch 46:
Position 1: first valve 38 (note-sounding plate) open/second valve 40 closed,
Position 2: first valve 38 (note-sounding plate 22) closed/second valve 40 open
Position 3: valve 38 (note-sounding plate 22) closed/second valve 40 closed

It is provided that after the user has heard the acoustic signal for a sufficiently long time and as a result of the reasons listed (for example, clattering) the user changes the valve position. In this example, from position 1 to 2.

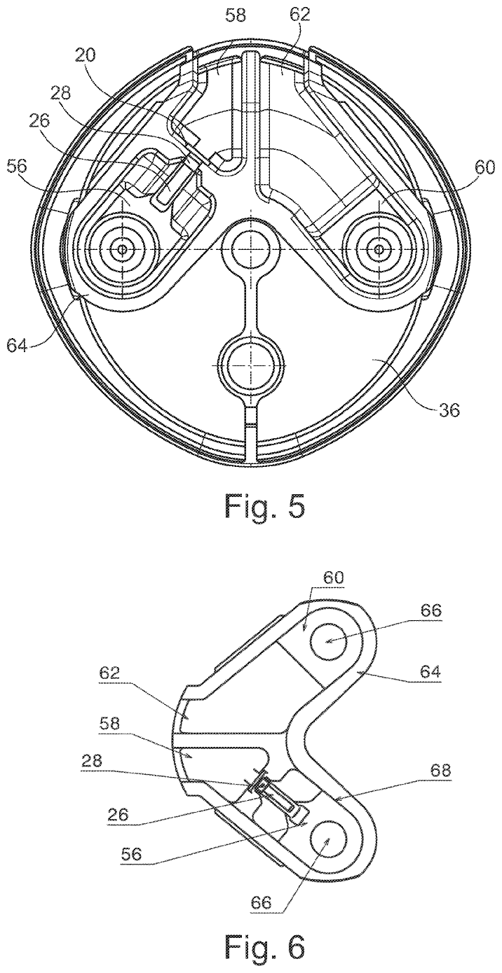

FIG. 5, which shows a view of the lid handle 36 from underneath illustrates that a first flow channel 56 leads from a first opening 39 in the base plate 37 to a first outlet opening 58. A second flow channel 60 leads from the second opening 41 in the base plate 37 to a second outlet opening 62. The note-sounding plate system 20, i.e. the note-sounding plate 22 with the note-sounding tongue 26 is arranged inside the first flow channel 56. The lid handle 36, in particular the two flow channels 56, 60 and the two valves 38, 40 are sealed by means of a form seal 64 with respect to the base plate of the low-pressure vessel lid.

FIG. 6 shows the form seal 64 with inserted note-sounding plate system 20 released from the lid handle 36. The first flow channel 36 has a wall 68 which can preferably be fabricated from a material which has a higher thermal capacity than the note-sounding plate system 20. Alternatively, a component not shown having such a higher thermal capacity can be provided in the first flow channel 58. In particular, it is also possible that the entire form seal 64 is formed from a material having higher thermal capacity.

Openings 66 for the spring-loaded pins 53 can be identified in the form seal 64.

In particular, FIGS. 5 and 6 show the arrangement of the note-sounding plate system 20 according to the disclosure in the lid handle 36. It can be seen that this is arranged obliquely with respect to the perpendicular or flow direction and preferably encloses an angle of 35 to 55°, preferably 45° with an underside of the first flow channel 56 formed by a surface of the low-pressure vessel lid, in particular the base plate 37. In particular, the note-sounding tongue foot is facing the base plate 37 so that accumulating condensate flows due to gravity in the direction of the note-sounding tongue foot 28 and the air gap 25 surrounding the note-sounding tongue 26 remains largely free as a result.

The form seal 64 is preferably formed as a separate and removable element, preferably made of silicone.

The disclosure is not restricted to the depicted exemplary embodiments and features but also covers further features which lie within the scope of protection of the patent claims.

For example, in addition to the positioning of the note-sounding plate system in the lid handle 36, other installation positions are also feasible. Thus, the note-sounding plate system 36 can, for example, be installed in a recess in the lid or the vessel wall. Likewise, a concealed installation in one or both side handles of the vessel is feasible.

1. A low-pressure vessel lid comprising
a plate-shaped base plate for placing on a vessel edge of a low-pressure vessel,
a first opening in the base plate,
an acoustic signal device for detection of a boiling point of a liquid which is heated in the low-pressure vessel,
wherein
the signalling device comprises a note-sounding plate system with a note-sounding plate and a note-sounding plate opening and a note-sounding tongue, wherein the note-sounding plate system is arranged in a first flow channel which extends from the first opening in the base plate to a first outlet opening so that the note-sounding tongue is excited by out-flowing liquid and generates a signalling tone of at least 40 dB.

2. The low-pressure vessel lid according to claim 1, wherein a first valve is provided via which the first opening in the base plate of the low-pressure vessel lid is configured to can be closed by an actuating means which prevents the excitation of the note-sounding plate.

3. The low-pressure vessel lid according to claim 1, wherein an excess pressure valve is provided and arranged in the first flow channel.

4. The low-pressure vessel lid according to claim 1, further comprising a component having a thermal capacity which is higher than the thermal capacity of the note-sounding plate system, said component being located inside the first flow channel.

5. The low-pressure vessel lid according to claim 1, wherein the wall of the first flow channel is fabricated from a material which has a higher thermal capacity than the note-sounding plate system.

6. The low-pressure vessel lid according to claim 1, wherein a second opening is provided in the base plate of the low-pressure vessel, through which fluid can also be guided from the low-pressure vessel.

7. The low-pressure vessel lid according to claim 6, wherein a second valve is provided wherein the second opening is configured to close with an operating means.

8. The low-pressure vessel lid according to claim 7, wherein the first valve and the second valve can be actuated by a snap-in rocker switch.

9. The low-pressure vessel lid according to claim 1, wherein a lid handle with a lid handle housing is provided in which the following are arranged:
the signalling device with the note-sounding plate system,
a first flow channel which opens into the first outlet opening,
the second flow channel which opens into the second outlet opening.
the first valve for closing the first opening, and
the second valve for closing the second opening,
wherein the rocker switch for actuating the two valves is arranged on the housing.

10. The low-pressure vessel lid according to claim 1, wherein the note-sounding tongue is surrounded by an air gap having a total area corresponding to a maximum of 4% of the area of the note-sounding plate opening.

11. The low-pressure vessel lid according to claim 1, wherein the note-sounding plate system delivers a tone having a frequency below 400 Hz.

12. The low-pressure vessel lid according to claim 1, wherein the note-sounding plate system is aligned obliquely to the longitudinal extension of the substantially horizontally running flow channel, and encloses an angle of 35 to 55° with an underside of the first flow channel.

13. The low-pressure vessel lid according to claim 12, wherein the note-sounding tongue is fastened to the note-sounding plate with a note-sounding tongue foot, wherein the note-sounding plate foot is aligned in the direction of the base plate of the low-pressure vessel lid, so that condensate which occurs can flow off in the direction of the note-sounding plate foot as a result of gravity.
